(19) United States
(12) Patent Application Publication
(10) Pub. No.: US 2009/0069008 A1
(43) Pub. Date: Mar. 12, 2009

(54) SITUATIONAL BANDWIDTH ALLOCATION IN SPECTRAL REUSE TRANSCEIVER

(76) Inventors: William R. Highsmith, Indiatlantic, FL (US); Paul G. Greenis, Indian Harbour Beach, FL (US)

Correspondence Address: FELDMANGALE, P.A., 1700 Market Street, Suite # 3130, Philadelphia, PA, 19103, US

(21) Appl. No.: 12/172,019

(22) Filed: Jul. 11, 2008

Related U.S. Application Data
(63) Continuation-in-part of application No. 11/532,306, filed on Sep. 15, 2006.
Application No. 11/532,306 is a continuation-in-part of application No. 10/730,753, filed on Dec. 8, 2003, now Pat. No. 7,457,295.
(60) Provisional application No. 60/784,105, filed on Mar. 20, 2006.

(51) Int. Cl. H04W 24/00; H04W 8/00

(52) U.S. Cl. 455/424; 455/452.1

(57) ABSTRACT

A situational or flexible bandwidth management system which enables management applications to control the allocation of bandwidth in a cellular network of spectral reuse transceivers based on network conditions.

### CROSS-REFERENCE TO RELATED APPLICATIONS

The present application is a continuation-in-part of and claims the benefit of previously filed, co-pending U.S. patent application Ser. No. 10/730,753, filed Dec. 8, 2003, by Brent Saunders et al, entitled: “Radio Communication System Employing Spectral Reuse Transceivers” (hereinafter referred to as the '753 application), and further claims the benefit of previously filed, co-pending U.S. patent application Ser. No. 11/532,306, filed Sep. 15, 2006 by E. Gerhardt et al., entitled: “Spectral Reuse Transceiver-based Aggregation of Disjoint, Relatively Narrow Bandwith (voice) Channel Segments of Radio Spectrum for Wideband RF Communication Applications” (herein referred to as the '306 application), which incorporates by reference and claims priority to U.S. Patent Application Ser. No. 60/784,105, filed Mar. 20, 2006, by E. Gerhardt et al, entitled: “Link Utilization Mechanism for Aggregation of Disjoint Radio Bandwidth,” (herein referred to as the '105 application), the disclosures of the above three applications, each being incorporated herein by reference. Also incorporated by reference herein is the contemporaneously filed, co-pending U.S. patent application by B. Kattwinkel, entitled: “Cost Efficient Spectral Reuse Transceiver,” hereinafter referred to as the “Cost Efficient Spectral Reuse Transceiver Application”.

### FIELD OF THE INVENTION

The present invention relates in general to communication systems and subsystems thereof, and is particularly directed to a ‘situational’ or ‘flexible’ bandwidth allocation control mechanism that may be employed by the communications controller of a spectral reuse transceiver of a communication system of the type disclosed in the above-identified '753 application, to redistribute bandwidth in cell networks to one or more cells whose base stations have failed, in a manner to restore radio service to the whole network; or to dynamically redistribute bandwidth from cells with lower bandwidth requirements to at least one cell with greater need of bandwidth in a manner whereby available bandwidth matches need.

### BACKGROUND OF THE INVENTION

As described in the above-identified '753 application, in some radio bands, such as the 217-220 MHz VHF band, as a non-limiting example, governmental licensing agencies (e.g., the Federal Communications Commission (FCC)) customarily grant primary licensees non-exclusive use of the band for a variety of communication services, such as push-to-talk voice transmission. These primary users pay for this licensed use with an expectation that they will not encounter interference by other users. The FCC also allows secondary users to access the same band and the same channels within the band on a ‘non-interfering’ or secondary basis, whereby a channel may be used by a secondary, non-licensed, user, so long as the primary user is not using that channel.

The FCC and similar agencies in foreign countries are continually looking for ways that allow expanded use of these licensed radio frequency bands, without reducing the quality of service available to the primary users. For secondary users, these bands provide a cost-free opportunity with excellent radio transmission properties for telemetry and other applications. Because secondary users must not interfere with primary users, complaints of interference from a primary user to the FCC may result in its issuing an administrative order requiring that the secondary user move to another portion of the band or leave the band entirely. Such a spectral transition is disruptive to the secondary user's service and can be expensive, especially if site visits, equipment modification, or exchange are required, in order to implement the mandated change. It will be appreciated, therefore, that there has been a need for a mechanism that allows a secondary-user to employ a licensed band on a non-interfering basis and will adapt the radio's frequency usage should new primary users appear. It should be noted that primary users always have priority over secondary users, there is no first-use channel frequency right for secondary users.

Advantageously, the invention described in the above-referenced '753 application successfully addresses this need by means of a monitored spectral activity-based link utilization control mechanism. Briefly reviewing this link utilization control mechanism which may, without limitation, be used with a star-configured communication system such as that depicted in the reduced complexity diagram of FIG. 1, a spectral reuse transceiver installed at a master site 10 communicates with respective spectral reuse transceivers installed at a plurality of remote sites 12. Each spectral reuse transceiver operates with a selectively filtered form of frequency hopping for producing a sub-set of non-interfering radio channels or ‘sub-channels’. It should be noted here that other configuration or network topologies may be used consistent with the invention disclosed herein. Thus the invention may be used with radio links between transceivers in other topologies, such as point-to-point, and individual links in mesh networks, without limitation, consistent herewith.

For this purpose, the master site 10 periodically initiates a clear channel assessment routine, in which the master site and each of the remote sites 12 participate, in order to compile or ‘harvest’ a list of non-interfering or ‘clear’ sub-channels (such as 6.25 KHz wide sub-channels), which may be used by participants of the network for conducting communication sessions that do not ostensibly interfere with any licensed user. By transmitting on only sub-channels that have been determined to lie within clear channels, a respective site's spectral reuse transceiver is ensured that it will not interfere with any primary user of the band of interest.

Except when it is transmitting a message to the master site, each remote user site sequentially steps through and monitors a current list of clear sub-channels previously obtained from the master site, in accordance with a pseudo-random (PN) hopping sequence that is known a priori by all the users of the network, looking for a message that may be transmitted to it by the master site transceiver. During the preamble period of any message transmitted by the master site, each remote site's transceiver scans all frequency bins within a given spectrum for the presence of energy. Any bin containing energy above a prescribed threshold is marked as a non-clear sub-channel, while the remaining sub-channels are identified as clear and therefore available for reuse sub-channels.

Whenever a remote site notices a change in its clear channel assessment, it reports this to the master site. As the master site has received clear sub-channel lists from all the remote sites, it logically combines all of the clear channel lists, to produce a composite clear channel list. This composite clear channel list is stored in the master site's transceiver and is broadcast to all of the remote sites over a prescribed one of the clear sub-channels that is selected in accordance with a PN sequence through which clear sub-channels are selectively used among the users of the network. When the composite clear channel list is received at a respective remote site it is stored in its transceiver.

To ensure that all communications among the users of the network are properly synchronized in terms of the composite clear channel list and the order through which the units traverse, or ‘hop’ through, that list, the master site's transceiver transmits an initialization message on an a priori established clear sub-channel, which each of the remote units monitors. This initialization message contains the clear channel list, an identification of the preamble sub-channel, a PN sequence tap list, and a PN seed that defines the initial sub-channel and hopping sequence for the duration of an upcoming transmit burst. Once a remote site has received an initialization message, that site will transition to normal multiple access mode.

The architecture and operation of the spectral reuse link control mechanism is disclosed in the above-referenced '753 application and is not explicitly detailed herein order to focus the present description on the problem of bandwidth reallocation, whereby outages of a cellular network cells are advantageously alleviated through bandwidth reallocation from adjacent cellular network cells; and whereby sudden, large geographic shifts of cellular network usage, resulting in poor service in the affected areas, is advantageously alleviated by reallocating bandwidth from lesser-used cells in the network.

### SUMMARY OF THE INVENTION

In accordance with the present invention, this failed cell bandwidth coverage problem is successfully addressed by equipping the spectral reuse transceiver (‘transceiver’) communications controller with a dynamic bandwidth reallocation control mechanism, operative in spectral reuse base stations in adjacent cells whereby said base station transceivers in adjacent cells expand their coverage area to jointly encompass the geographic cell area of a failed cell. If, for example, the failed cell has five adjacent neighbors, then the said adjacent transceiver typically would expand coverage to cover about one-fifth of the geographic area of the failed cell. The present invention could be used with multicarrier transceivers of the type disclosed in the aforementioned '753 application and single-carrier radios of the type disclosed in the aforementioned ‘Cost Efficient Spectral Reuse Transceiver Application.

In accordance with another embodiment of the present invention, the cellular network bandwidth distribution problem wherein cellular networks sometimes have unevenly distributed user traffic is successfully addressed by equipping the transceiver's communications controller with a dynamic bandwidth reallocation control mechanism, operative in spectral reuse base stations whereby said base station transceivers are directed to reduce or increase their bandwidth, depending on whether they have reduced band requirements or increased bandwidth requirements, respectively. For example, if a cell supporting public safety communications suddenly has a large convergence of users because of a local emergency, the present embodiment advantageously mitigates against this uneven distribution of demand by redistributing some bandwidth from less busy cells in the network to one or more busier cells. The embodiment uses one or more prescribed traffic measurement discriminators to control the manner in which bandwidth usage is measured and thereby redistributed. The discriminators may include the priority of the traffic, number of users joined to the cell, percentage of available bandwidth used, and backlog (queued traffic). Automatic traffic management applications (‘applications’) may control policies to favor certain applications, such as police and fire brigade transceivers, in the present example. The said applications may also perform general, continual leveling of bandwidth to match the current traffic requirements.

A first of these discriminators involves identifying the priority of the transceivers' traffic. The priority may be assigned based on the radio serial number, or the user ID logged into the radio, or the vehicle ID, or the application type such as voice, data, telemetry, and based on other criteria such the source or destination of the traffic, or fields in the data communication packet headers, and other means of prioritizing transceiver traffic that will be understood by one skilled in the art.

A second of these discriminators is the number of transceivers joined to the cell. The cell's base station transceiver communications controller or, alternatively, a central communications controller will typically note when a transceiver enters or joins a cell and when the transceiver leaves a cell. The number of joined transceivers is one indicator of needed capacity.

A third discriminator generally measures user traffic or offered load, such as percentage of available bandwidth used, backlog (queued traffic), the number of packets transmitted and received during a measurement period and others understood by one skilled in the art. These traffic or offered load statistics are commonly measured and stored in communications networks and are another indicator of needed capacity. These and other discriminators may be used to form policies that the automatic traffic management applications may use to redistribute bandwidth within the cellular network, according to the present invention.

### BRIEF DESCRIPTION OF THE DRAWINGS

FIG. 1 diagrammatically illustrates the overall architecture of a communication network, with respective terminal unit transceiver sites which employ the spectral reuse transceiver of the invention disclosed in the above-referenced '753 application;

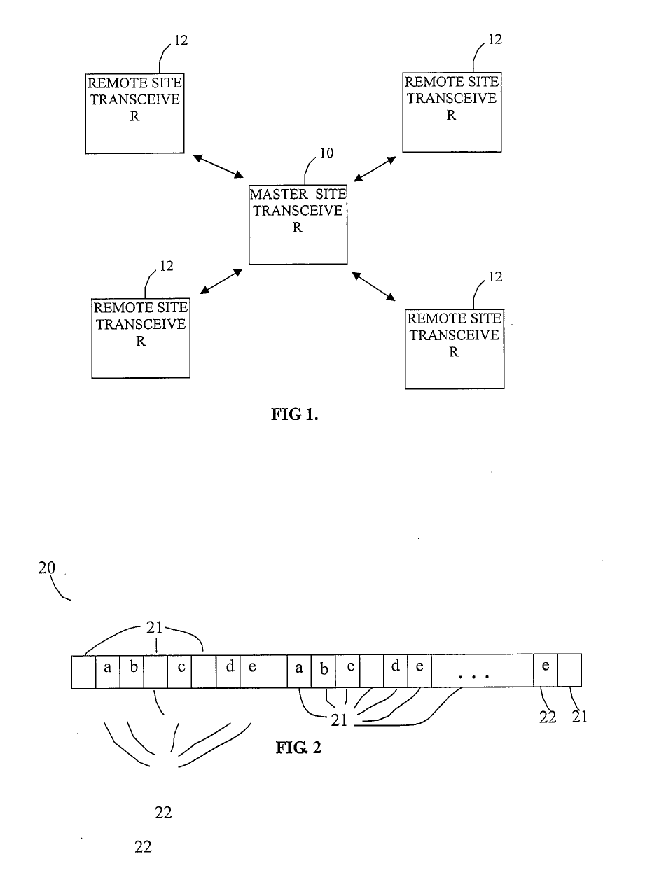

FIG. 2 graphically illustrates the partitioning of a radio band into sets of sub-channels, each set used for carrying traffic for a cell in a cellular network, using spectral reuse transceivers of the type described in the above-referenced '753 application;

FIGS. 3a and 3b graphically illustrate the expansion of cell coverage to cover the geographical area of a failed cell, according to one embodiment of the present invention; and

FIGS. 4a and 4b graphically illustrate the redistribution of bandwidth from less-busy cells in a cellular network to more-busy cells, according to one embodiment of the present invention.

### DETAILED DESCRIPTION

Before describing the details of the ‘situational’ bandwidth reallocation control mechanism of the present invention, it should be observed that the invention essentially involves an augmentation of the sub-channel hopping control mechanism executed by the communications control processor of the spectral reuse transceiver of the type disclosed in the above-referenced '753 application and ‘Cost Efficient Spectral Reuse Transceiver Application, that involves the execution of one or more prescribed sub-channel discriminators or sub-channel selection filters, so as to effectively redistribute bandwidth to a geographical area within a cellular network. As will be described, these filter functions are readily implemented by appropriately setting the configuration parameters used by the communications controller of the transceiver disclosed in the '753 application and the ‘Cost Efficient Spectral Reuse Transceiver Application to control the operation of the transceiver. The architecture of the transceiver of the '753 application and ‘Cost Efficient Spectral Reuse Transceiver Application may remain unchanged. As a consequence, the present invention has been illustrated in the drawings by readily understandable diagrammatic illustrations, which include a generalized network architecture diagram, and a sub-channel division diagram, that show only those details that are pertinent to the invention, so as not to obscure the disclosure with details which will be readily apparent to one skilled in the art having the benefit of the description herein.

As pointed out briefly above, an essential objective of each of the aforementioned sub-channel discriminators of the augmentation to the sub-channel hopping control mechanism in accordance with the invention is to redistribute bandwidth to geographic locations to mitigate against equipment failure of one or more cells in a cellular network, or to redistribute bandwidth to the cells where bandwidth is most needed within a cellular network. Non-limiting, but preferred, examples of such discriminators include: 1—constraining the transceivers to cognitively find a proscribed number of available and usable sub-channels; 2—constraining the transceivers to operate using a manually determined and configured set of available and usable) sub-channels; and 3—configuring the transceivers to aggregate a proscribed set of available sub-channels, according to the aforementioned '105 application. The operation and effect of each of these discriminators will be discussed individually below.

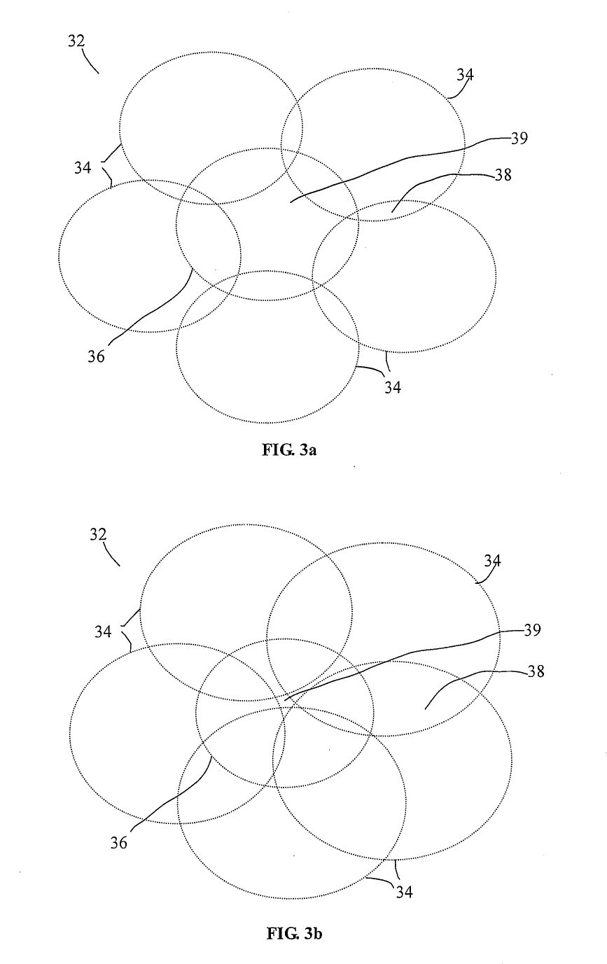

To facilitate an understanding of the functionality and effect of the sub-channel discriminators, attention may be directed to FIG. 2, which graphically illustrates the relationship between used and unused sub-channels in a spectral reuse transceiver of the type described in the above-referenced '753 application. In the graph 20 of FIG. 2, a radio band is illustrated as a set of unavailable or unused channels 21 and a set of available channels 22. Further, available channels 22 are further divided into subsets, where all sub-channels 22a are currently assigned to ‘cell a’, all sub-channels 22b are assigned to ‘cell b’, and so on. Conventionally, sub-channels 21 and 22 of graph 20 are numbered sequentially from 1 to the highest sub-channel number in the particular radio band, for example, channels 1 to 512, if there are 512 sub-channels in the band.

One way to configure a transceiver of the '753 application or ‘Cost Efficient Spectral Reuse Transceiver Application to use ‘n’ sub-channels is to configure said transceiver to cognitively find ‘n’ sub-channels that are available and are not administratively or otherwise blocked from use. Another way to configure a transceiver of the '753 application or ‘Cost Efficient Spectral Reuse Transceiver Application to use ‘n’ sub-channels is to configure said transceiver to use an explicitly selected set of ‘n’ channels which could be done, for example, by providing a list of sub-channels to use via a network management or element management software application. Yet another way to configure a transceiver of the '753 application or ‘Cost Efficient Spectral Reuse Transceiver Application to use ‘n’ sub-channels is to configure said transceiver to ‘aggregate’ an explicitly selected set of ‘n’ channels according to the aforementioned '105 application.

It should be understood that the term ‘cellular network’ is not limited to carrier-based cellular telephone networks; the present inventions are directed to a more general meaning, wherein a cellular network is organized as a series of adjacent hub-and-spoke networks or mobile networks which are, typically, interconnected through a backhaul network, including data, voice and mixed networks. As a non-limiting, but practical illustration of the embodiments of the present invention, consider a public safety radio band that supports police or fire first responders. This is a critical application that may be partially disabled if one or more of the cells in the network is disabled. In another scenario, suppose there is a major public safety issue in a particular area, such as a major fire, storm, explosion or hostage situation. In this case, the first responders of various public service agencies may have a larger-than-normal convergence in a small area. The affected cell areas may be inadequate to support the above-average traffic load, while other cells are idle because of the unusual distribution of first responder vehicles and personnel.

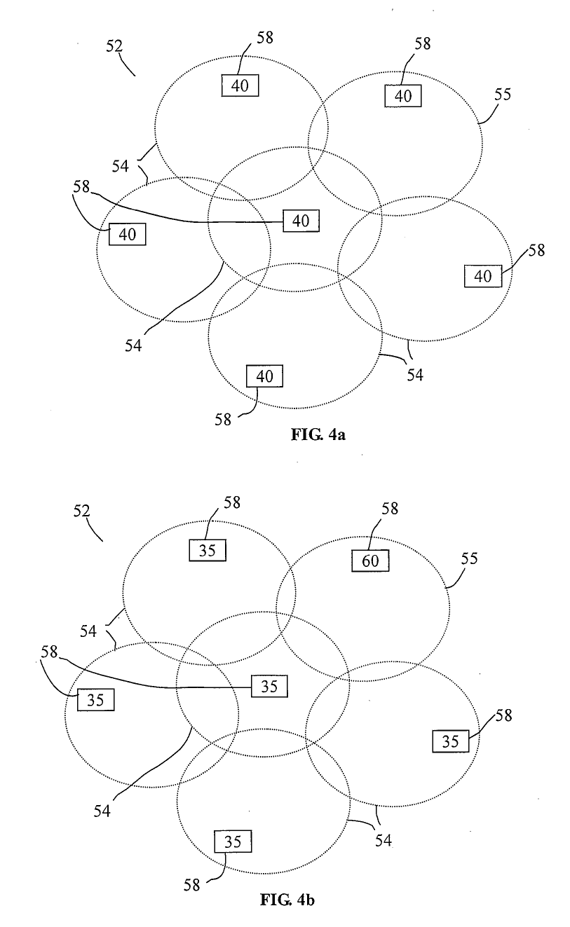

Referring now to FIG. 3a, in cellular network 32, there are five surrounding cells 34 and an interior cell 36. Interior cell 36 differs from cells 34 only in its relative position in this non-limiting example configuration. Each of the cells 34 and 36 have overlap areas 38 with other cells 34 and 36, although only one overlap area is pointed out in the figure so as not to clutter the figure. These overlaps are typical in cellular networks so as to provide continuous coverage over a region. Similarly, each cell has a non-overlapped area 39; only the non-overlapped area 39 of inner cell 36 is shown so as not to clutter the drawing. Each of the cells in network 32 would typically have a base station transceiver (not shown) and one or more remote transceivers (not shown) communicating therewith. Also not shown is a backhaul network, typically used to link the cells to a central location for data and voice switching and for managing the cells' transceivers.

Referring now to FIG. 3b, interior cell 36 of FIG. 3b has failed. Therefore, according to the present invention, the surrounding cells 34 of FIG. 3b have expanded their coverage area, so that most of the area of interior cell 36 is covered thereby, except for a small area 39, this combination of covered and non-covered areas shown being a non-limiting example. Thus, nearly full coverage area is restored to the cellular network, in the example, since the surrounding cells 34 had sufficient radio coverage expansion capability. Full coverage could be achieved if the transceivers have greater expansion capability. Typically, a network monitoring and management system (‘NMS’) would detect the failure of the transceivers in the failed interior cell 36 through the use of one or more status indicators, sensors or management applications, as is well-known to one skilled in the art, and, using network management messages or similar means direct the surrounding cells' 36 transceivers to expand their radio coverage. Network monitoring, fault detection and network management techniques to implement the described failure recovery are well-known to one skilled in the art. The present invention allows for the coordinated radio coverage expansion of the surrounding cells. The transceivers, once directed to expand their coverage area, expand their coverage area, for example, by lowering their bandwidth, increasing their transmit power, decreasing the receiver attenuation thereby increasing their receiver sensitivity, or a combination thereof, as is well known to one in the radio art. Similar effects can be accomplished or assisted through the use of ‘smart’ antennas, whose transmit/receive patterns can be shaped through electrical controls (often called ‘beam-shaping’), for example. These coverage expansion methods may be used with the transceiver of the aforementioned '753 application and ‘Cost Efficient Spectral Reuse Transceiver Applications.

Note also in FIG. 3b that the overlap area 38 has expanded, following the expansion described in the foregoing discussion, compared to overlap area 38 of FIG. 3a. This illustrates that the expansion scheme (said expansion conducted by one or more cells adjacent to one or more failed edge cells), as described above may also be used to at least partially and similarly restore cellular radio area coverage for the failure of one or more edge (non-interior) cells.

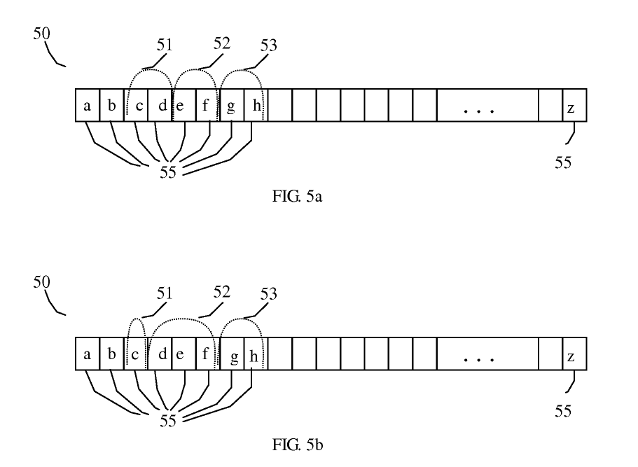

Referring now to FIG. 4a, a cellular network is shown with a non-limiting example of five cells 54 and a similar cell 55. Not shown in each of the cells 54 and 55 are a base station transceiver and one or more remote transceivers communicating with their respective base station transceiver. In the present example, all transceivers in the cellular network are spectral reuse transceivers of a communication system of the type disclosed in the above-identified '753 application. Thus the transceivers of the present invention have adjustable bandwidth, the bandwidth determined by the number of sub-channels 58 the transceivers are assigned by a management system (not shown). In the present, non-limiting example, each transceiver 54 and 55 have 40 sub-channels 58.

Now suppose that, as described earlier in the public safety example, there was an event in the geographic area of cell 55, resulting in the convergence of many public safety first responders to cell 55. In this non-limiting scenario, the default bandwidth of 40 sub-channels 58 might be insufficient to support the sudden influx of network users. According to the present invention, therefore, a network management application (not shown) will reconfigure cells 54 so that they have thirty-five sub-channels 58 instead of forty, as shown in FIG. 4b. The five sub-channels removed from each of cells 54 are added to cell 55, so that cell 55 now has 60 sub-channels in FIG. 4b. By this reconfiguration, the bandwidth of nearby cells 54 is redeployed to one cell 55 with a dynamic need for additional bandwidth. Similarly, if two or more of cells 54 and 54 had received a sudden influx of users rather than just cell 54 of the previous example, then sub-channels from other cells could be redeployed to the newly busy cells and distributed thereover. Similarly, the present invention may be used for sudden traffic spikes in the network, even without apparent influxes of new users attending an emergency.

Various methods will be apparent to one skilled in the art to detect the influx of new users and spikes of traffic. For example, new mobile transceivers in a cell will have cell joining process and a cell exiting or timeout process that the base station transceiver communications controllers therein may detect. Similarly, the base station transceiver communications controllers can detect increased demand on the network by measuring queue lengths, usage statistics, transmission collisions and the like. Once the influx or traffic increase is measured, a network management system would configure the providing cells with fewer sub-channels and the receiving cells with more sub-channels.

It should be appreciated that the transceiver of the above-identified '753 application has the capability to transmit multiple sub-channels simultaneously, and can continuously hop to a new sets of available sub-channels to minimize dwell time thereby using all of the available bandwidth over time, or can remain constrained within a fixed set of sub-channels, or can hop around interference discovered cognitively. The present invention, and some of its embodiments, rely on this transceiver's unusual ability to transmit on multiple sub-channels and adjust its total bandwidth by dynamically changing the number of sub-channels simultaneously transmitted. In one embodiment, the base station transceivers are configured to cognitively find and use ‘n’ sub-channels for simultaneous transmissions, changing the ‘n’ sub-channels any time that one or more interfering signals arise. In another embodiment of the present invention, the base station transceiver is configured to aggregate ‘n’ sub-channels for simultaneous transmissions, changing the ‘n’ sub-channels when further configured, according to the aforementioned '105 application. In another embodiment of the present invention, the base station transceiver is configured to restrain itself to a set of ‘n’ sub-channels for simultaneous transmissions, changing the ‘n’ sub-channels when further configured, according to the aforementioned '753 application.

As will be appreciated from the foregoing description, dynamic re-use of bandwidth within a cellular network provides substantially more flexibility and quality of service for critical applications like public safety first-responder communications, and for more mundane applications that also have geographically wide fluctuations in traffic.

While we have shown and described several embodiments in accordance with the present invention, it is to be understood that the same is not limited thereto but is susceptible to numerous changes and modifications as known to a person skilled in the art There is no intention that this application be limited to the details shown and described herein, but it is intended to cover all such changes and modifications as are obvious to one of ordinary skill in the art.

In FIG. 5a, there is a band 50 comprising channels 55a-z. One single-channel transceiver (not shown) is transmitting signal 51 comprising channels 55c-d. Another single-channel transceiver (not shown) is transmitting signal 52 comprising channels 55e-f.

In FIG. 5b, the single-channel transceiver (not shown) of signal 51 has reduced its channel bandwidth, compared to signal 51 of FIG. 5a, so that said transceiver's signal 51 now comprises only one channel 55c. The single-channel transceiver (not shown) of signal 52 has expanded so that said signal 52 now comprises three channels 55d-f.

Similarly, the single-channel transceiver (not shown) of signal 53 could also reduce its bandwidth so that said transceiver was only using channel 55h, so that the single-channel transceiver of signal 52 could further expand to include channel 55g.

Thus FIGS. 5a and 5b illustrate by this reconfiguration, that the bandwidth of nearby transceivers or cells may be redeployed to one transceiver or cell with a dynamic need for additional bandwidth. Similarly, if two or more transceivers or cells had received a sudden influx of users, then bandwidth from nearby transceivers or cells could be redeployed to the newly busy transceivers or cells and distributed thereover. Similarly, the present invention may be used for sudden traffic spikes in the network, even without apparent influxes of new users attending an emergency.

What is claimed:

1. A method for expanding cell coverage areas to cover one or more failed cells, comprising steps of:
(a) determining that a cell has failed.
(b) expanding the adjacent cells to provide coverage for the coverage area of the failed cell.

2. The method of claim 1 where step a. comprises one or more of the steps from the group comprising; (a) reading transmit power sensors for each cell in the network, a low-threshold value indicating a failure; (b) polling each base station transceiver for health status from a central network management system; and (c) accumulating reports from mobile transceivers indicating which cell pilot signals are detected.

3. The method of claim 2 where step (c) comprises using geo-location information from GPS devices or through triangulation to determine if a mobile transceiver should be able to see a cell's base station pilot.

4. Claim 1 where step b comprises one or more of the steps from the group comprising (a) lowering the adjacent cells' transceiver's bandwidth; (b) increasing the adjacent cells' transceiver's transmit power; (c) increasing the adjacent cells' transceiver's receive sensitivity; and (d) shaping the beam of the adjacent cells' antenna.

5. The method of claim 1 wherein the transceiver is a spectral reuse transceiver of the type described in the '753 application.

6. The method of claims 1 where the transceiver is a cost efficient spectral reuse transceiver.

7. The method of claim 1 wherein the failed cell is an edge cell.

8. A method for redistribution of bandwidth in a cellular network to accommodate fluctuations in traffic load, comprising steps of:
(a) measuring the traffic in each cell in a cellular network;
(b) using a policy to determine how much bandwidth to subtract from less busy cells and how much bandwidth to add to more busy cells, based on the measured traffic of step a;
(c) reducing the bandwidth available to lower-traffic cells according to the policy; and
(d) increasing the bandwidth available to higher-traffic cells, using the bandwidth subtracted from the lower-traffic cells, according to the policy of step b.

9. The network of claim 8 wherein step a. comprises one or more of the steps of:
(a) measuring the number of transceivers joined to each cell of the network;
(b) measuring the queue depth of each transceiver in each cell in the network;
(c) measuring the number of high-priority transceivers and users joined in each cell;
(d) measuring the total traffic in each cell; and
(e) measuring the percentage of available bandwidth used at each cell of the network;

10. The network of claim 9 wherein one or more of steps (a) to (c) include geolocation using a GPS devise or triangulation to determine in which cell transceivers are joined.

11. The method of claim 8 wherein the cell network comprises spectral reuses transceivers of the type described in the aforementioned '753 application.
